(19) United States
(12) Patent Application Publication
(10) Pub. No.: US 2005/0015302 A1
(43) Pub. Date: Jan. 20, 2005

(54) Methods and apparatus for minimizing waste in vending machines

(75) Inventor: Bob M. Dobbins, Villanova, PA (US)

Correspondence Address: PRIEST & GOLDSTEIN PLLC, 5015 SOUTHPARK DRIVE, SUITE 230, DURHAM, NC, 27713-7736, US

(73) Assignee: Ellenby Technologies, Inc., Woodbury Heights, NJ (US)

(21) Appl. No.: 10/879,980

(22) Filed: Jun. 28, 2004

Related U.S. Application Data
(60) Provisional application No. 60/483,721, filed on Jun. 30, 2003.

(51) Int. Cl. G06F 17/60

(52) U.S. Cl. 705/16; 705/28

(57) ABSTRACT

Approaches for minimizing waste in vending machines are addressed. A vend controller and vend control software determine when product having a limited shelf life is approaching the end of that shelf life and a display indicates to a customer that an appropriate discount exists if he or she wants to purchase the product. For vending machines connected in a monitoring network, the determination regarding approaching the end of the shelf life and an appropriate discount can be made remotely and transmitted to the vending machine, eliminating the need for increased complexity in the vending machine control electronics. Vending of stale products can be prevented using either approach and customers can be informed that the product is near the end of its shelf life and afforded an opportunity to knowledgably purchase the product or not, insuring increased customer satisfaction with the vending experience.

### RELATED APPLICATIONS

The present application claims the benefit of U.S. Provisional Application Ser. No. 60/483,721 entitled “Methods and Apparatus for Minimizing Waste in Vending Machines” filed Jun. 30, 2003, and which is incorporated by reference in its entirety.

### FIELD OF THE INVENTION

The present invention relates generally to improved techniques for minimizing product waste in vending machines. More particularly, the present invention relates to advantageous approaches to providing incentives for consumers to buy products near the end of their shelf life.

### BACKGROUND OF THE INVENTION

The vending industry has traditionally sought to optimize the number of products sold, to reduce the frequency of refilling the machines, and to increase the profit margins realized. Many strategies have been put in place to achieve this end. Among these strategies, vending machines have been provided with a variety of sophisticated microprocessor driven control systems, and sophisticated accountability systems have also been developed and deployed. In order to further optimize the returns from vending routes and reduce the frequency of restocking, products with relatively long shelf lives have been favored over fresher, but shorter shelf life products.

The “intelligence” of vending machines has been primarily developed to enhance the information available to the operators so that product sales and machine cash can be monitored and reported. These enhancements have been further supported by the vending industry through the development and support of standards for storing and reporting such information. One such standard is the European Vending Association Data Transfer Standard EVA-DTS, supported in the United States through the National Automatic Merchandising Association NAMA.

The “intelligence” of vending machines has further been developed to allow optimizing of sales by various other techniques. One such example is the use of “space to sales” features which allow several spirals or columns or shelves of products to be vended sequentially, or alternatively, by a common selection choice by the consumer. These approaches allow multiple vend columns, rows, spirals, shelves, or the like to be loaded with a common product to increase the quantity of that product without increasing the number of selection choices to the consumer. Another exemplary approach is the use of discounting. A typical approach to discounting allows a percentage or fixed amount to be taken off the normal product price to encourage sales of a particular product, multiple products when bought together, or for off hour purchases. Discounting is also used to favor a certain group of customers, such as teachers, managers, an employee of the month, or the like.

While the electronics controlling vending machines have increased in their capabilities, the industry is moving rapidly toward integrating vending operations through the use of various systems. These systems generally include a computer that tracks data collected by each of a large number of vending machines, programs the specific routes for refilling and collecting money from the machines, and determines the type and number of products required by each of the vending machines. These systems often communicate to the vending machines through the use of handheld probes which allow the route drivers to download the data from the machines visited, or through wired or wireless connections to the machines so the data can be collected in real time.

The combination of the enhanced electronics in many vending machines and the systems that are being used to manage the data from the machines makes use of the data to try and anticipate the volume of products required to maximize sales and minimize the number of route visits. However, efforts to manage and reduce waste due to food spoilage have typically been limited to attempting to minimize the amount of such food products, or of forcing increased route visits to insure that all products are fresh.

The demands of consumers for increased variety are forcing the introduction of a broader range of products in vending machines. Such products include more fresh products and increasingly fresh branded products. Besides health issues, manufacturers require their branded products to be sold fresh so that their brand name and reputation are not compromised. The systems in place today cannot assure products that are not fresh are not sold. The systems in place today can only minimize waste by helping to appropriately estimate the amount of products to be stocked. Such before the fact estimation while advantageous can never anticipate the ups and downs product demand experienced by individual vending machines.

### SUMMARY OF THE INVENTION

In a first embodiment, it is an object of the present invention to provide an electronic control system for a vending machine which keeps track of the shelf life of the products being vended and maximizes the chance of those products being sold by offering discounts before the shelf life expires.

It is a further object of the current invention to provide an electronic control system for a vending machine which can be utilized to prevent products which have exceeded their shelf life from being sold.

Another object of the current invention is to provide a vending machine controller which allows progressive discounts as products age.

A further object of the current invention is to provide a mechanism for inducing sales of products that are reaching the end of their shelf life with a programmable time and amount of discount.

It is yet another object of the current invention to allow a range of discounting of products in a vending machine with an expiration date that can be adjusted automatically by the controller based on the number of such products available and the rate these products are being purchased.

A further object of the current invention is to provide a mechanism for determining a variable discount rate based on current and past usage trends in an effort to insure that products sell out before the expiration of the products being sold.

Yet another object of the current invention is to provide monitoring circuits to detect the presence or absence of products to determine if discounting is required on an individual product basis.

In an alternative embodiment of the invention, a further object is to provide a system whereby the determination of the expiration of products in a machine is determined by a remote host system and a discount price is transmitted to the vending machine for those products whose shelf life is about to expire.

Yet another object of the current invention is to provide a system which determines the discount to be used in pricing products which would otherwise expire by analyzing the sales of these products and determining an appropriate discount to optimize revenues while insuring that maximum sales are realized.

It will be recognized that the present invention has the further advantage of being capable of providing a mechanism to allow customers to know that a product is nearing the end of its shelf life. With such information, the customer can make an informed decision as to whether to buy or not. While such an approach might be viewed as counterproductive in that in the short run a customer may choose not to purchase a product near the end of its shelf life, it insures long term customer satisfaction. Additionally, it is believed that it will increase long term sales by giving customers the knowledge they need to insure to their satisfaction that they will be purchasing sufficiently fresh products.

Other features and advantages of the present invention are described further below and will be readily apparent by reference to the following detailed description and accompanying drawings.

### BRIEF DESCRIPTION OF THE DRAWINGS

FIG. 1 shows a functional block diagram of an updateable vending system programmed to reduce product waste in accordance with the present invention;

FIG. 2 shows further details of an individual updateable vending machine in accordance with the present invention;

FIG. 3 is a flowchart of a process for one implementation of the logic sequence for a vend mode which reduces waste in vending machines in accordance with the present invention;

FIG. 4 is a flowchart of a process for one implementation of the logic sequence for a setup mode in accordance with the present invention; and

FIG. 5 is a sequence of display messages for one suitable implementation of the present invention.

### DETAILED DESCRIPTION

The present invention addresses the issue of excess product waste in vending machines resulting from products being discarded after reaching their expiration date. One way to minimize this waste is to sell these products before their expiration date. Increasingly sophisticated systems are being used which allow operators to track the cash and product sales and aid in reducing the time spent by route persons in refilling machines on their routes. The ability to update price data, and to report sales data, and the like are routinely being built into vending machine controllers. Sales data is then monitored to determine the product mix, sales price, and other parameters suitable to optimizing the profitability of these machines. However, such systems do not address the leftover product which must be discarded when it is no longer sellable due to product expiration.

The present invention teaches a number of ways to use either the electronic controller or the host system to change from a mode in which it performs the recording and tracking of information to a new dynamic control mode in which pricing is dynamically adjusted to induce sales for targeted products, such as those products about to reach the expiration of their shelf life. While the present discussion focuses on such products, it will be recognized that the advantageous techniques of the present invention can be applied to other products as well.

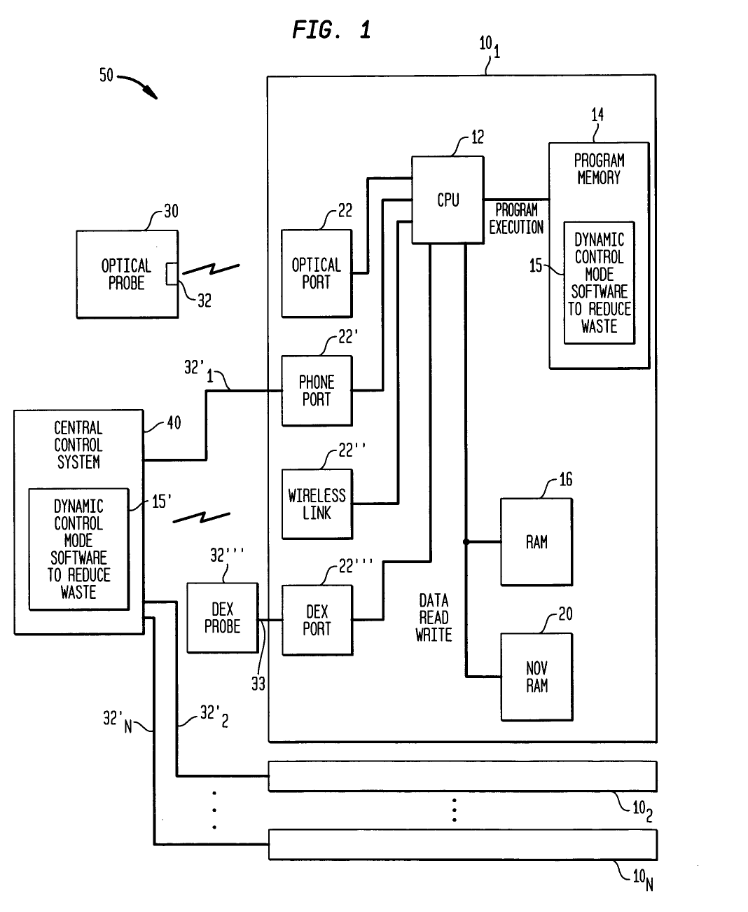

One such approach is described with reference to FIG. 1. In electronic vending machines, such as machines 10₁, 10₂ . . . , 10_{N} (collectively 10), shown schematically in FIG. 1, electronic controllers or central processing units (CPUs) 12 follow the logic for machine operation as determined by the program memory, addressed by the microcomputer or microcontroller being used. This program memory 14 may be a ROM, a PROM, an EPROM, flash, a combination thereof, or some other form of nonvolatile memory. It may be separate from a CPU 12 as shown in FIG. 1 or may be integrated or on a single microcontroller chip. Such controllers and software generally are well known in the industry. The instruction set used by the electronic controllers is used to control the processing of various tasks, such as recording the money being deposited into the machine, comparing the deposited amount to the price of the product being selected, and if the available credit equals or exceeds the product price, controlling vending of the selected product. Issues of available change, operation of motors or solenoids and the like are also handled by the instruction set of the controllers. The current invention adds dynamic control mode software to support and provide a level of analysis so that the electronic controller operates to determine if an adjustment needs to be made to the price of individual products to induce sales of those products.

As shown in FIG. 1, the vending machines 10 may also suitably include a random access memory (RAM) 16. In addition, the vending machines 10 may suitably include nonvolatile RAM (NOVRAM) 20. The CPU 12 is communicatively connected to an optical transceiver port 22′, a phone port 22′ a wireless link 22″ or a data exchange (DEX) port for communication with a central control system 40 either through an optical probe 30, phone lines 32′, . . . 32′_{N}, wireless links 22″ or a DEX probe. The exemplary optical update probe 30 includes an optical transceiver 32 which optically communicates with the vending machines 10 through the optical transceiver port 22. The DEX probe 32′″ is carried by a routeman who plugs it into the DEX port 22′″ with a plug connector 33. It will be recognized that any single vending machine might typically have only one type of communication port. Data from the vending machines 10 is typically provided to, collected by, and analyzed by a central control system 40. As shown in FIG. 1, the central control system 40 also includes dynamic control mode software to reduce waste 154′. It will be recognized that this software can be local in vending machines 10, in the central control system, or parts can be located in both units.

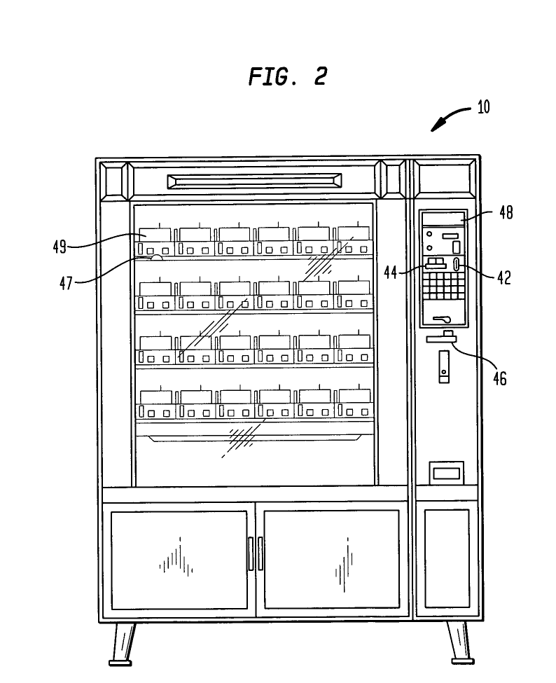

FIG. 2 shows further details of one of the vending machines 10 in accordance with the present invention. The exemplary vending machine 10 includes vending control electronics housed inside the vending machine 10. Additionally, the vending machine 40 includes a coin acceptor 42, a bill acceptor 44 and a card reader 46 housed within the outer housing of vending machine 10. A display 48 displays price, selection and discount messages to customers as discussed further below. Additionally, the vending machine 10 may include a monitoring circuit to monitor the presence or absence of products. For example, FIG. 2 shows an optical sensor 47 associated with a product selection 49 to detect the presence or absence of products. Each product location can have an associated sensor or vending of products can be sensed as they are selected in a known manner.

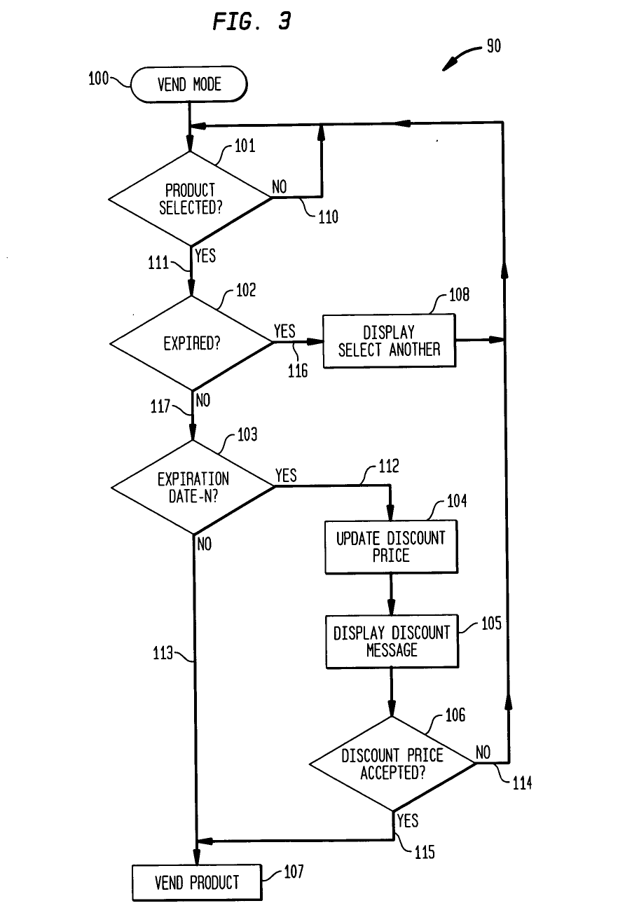

Turning to FIG. 3, the dynamic control mode analysis can be made by vend mode logic when a vend mode process 90 is entered in step 100 by the vending controller 12. The additional logic required would be used when a product selection is made using selection buttons on vending machine 10 during step 101.

When a product selection is made at step 111, the logic would cause controller 12 to first check the expiration date of the product at step 102. By way of example, expiration date data may be stored in NOVRAM 20 and downloaded into the vending machines 10 from the DEX probe 32′″ at the time the routeman stocks each vending machine. If the expiration date has not expired as indicated by decision path 117, the determination of discounting proceeds. Since in many vending machines the product price is displayed if the product is selected even if no credit exists, this approach provides an advantageous mechanism to notify the consumer of a price discount as discussed below.

The price will be checked if the expiration date is within a predetermined time in days or hours or some other time unit as appropriate. If the expiration date is not near the end of life of that particular product on decision path 113, the vend logic proceeds as normal to vend the product in step 107 at the product's normal price. In the event the expiration date is near the end of life on decision path 112, the discount price will be updated and used in place of the normally programmed price for that product in step 104. The determination of the discount price will be discussed later. If the price is to be changed and a discount offered, a message will be displayed on display 48 at step 106 to the consumer to allow him or her to decide whether to accept vending of this older product or not. Thus, if the consumer accepts the discounted product as indicated by decision path 115, the vend is continued. If the consumer chooses not to accept the discounted price on decision path 114, the electronic controller awaits a new product selection from the consumer.

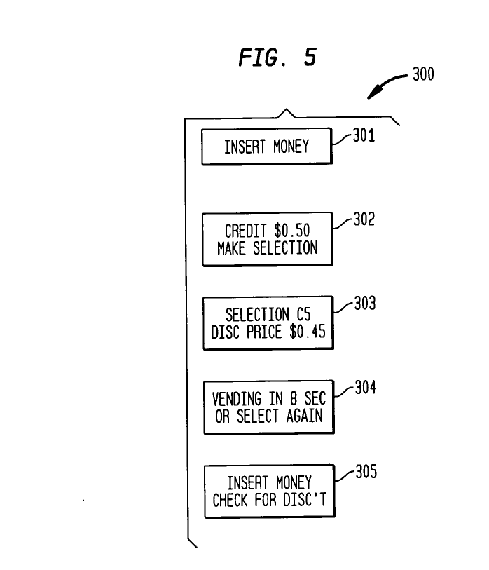

By way of example, the process of determining whether the consumer accepts the discounted price can be achieved without additional actions by the consumer by allowing a countdown message to show the remaining time to select an alternate product before the discounted product is vended. Of course, if the selection was made without credit, no such countdown timer would be required. One process 300 of displaying the countdown message is illustrated in FIG. 5. A normal message 301, such as MAKE A SELECTION, shown on a machine, such as machine 10, is displayed as usual. When money is inserted, a display message 302 will show the deposited amount and indicate a selection can be made, assuming sufficient credit is available. In this case, the controller 12 will include the discounted prices to determine if the minimum amount of credit exists to allow any vend to occur. If the consumer selects a product with a discount, the display will indicate the discounted price 303 for the selection made. The countdown display 304 will give the consumer the option of selecting another product within the remaining time, shown at 8 seconds, or else the vend will be completed at the discount price. Additional signs on the machine or a replacement idle message on the display might also be advantageously employed to alert the consumer that this machine has a discount feature for aging product. An exemplary message 304 alerts the consumer to check for discounts. Additionally, or as an alternative, the display may display a message indicating to the customer the fresh date for the product selected as discussed above, and the customer may be given the opportunity to cancel the selection or make a different selection.

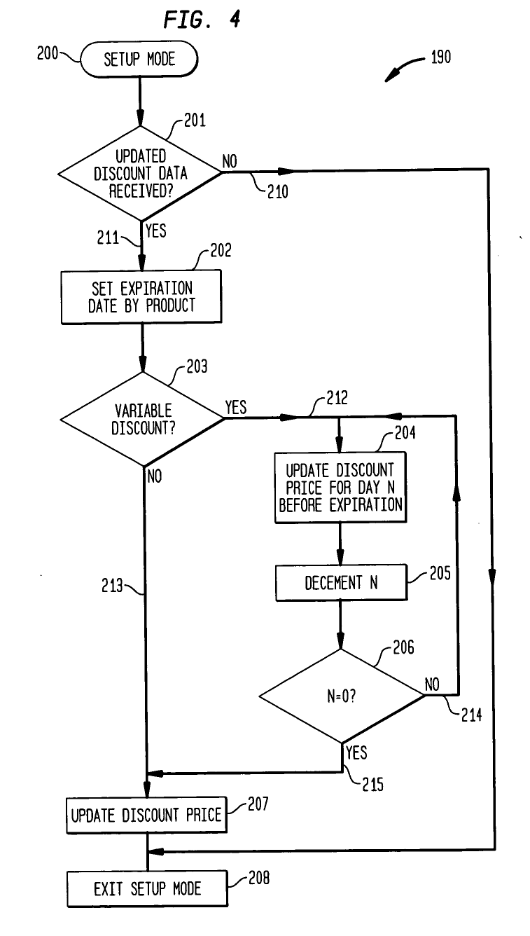

Referring now to FIG. 4, an exemplary process 190 may be used to determine the amount of discount to be applied as the date for expiration draws closer. This process 190 begins by entering the information relative to the expiration of a given product. Such information will be programmed into the vending machine as discussed above or through one of several techniques to be described below. If no such information is received as indicated by decision path 210, the system will ignore the discount setup mode and continue normal operation. If information is received as indicated by decision path 211, the expiration dates are set for each product 202. Several options exist to determine the amount of discount to apply, the example shown illustrates two such options. In the event a simple single discount is used, the test for use of a variable discount in step 203 will result in the process following path 213 to the simple discount price being set in step 207. If a variable discount is desired, the logic will follow the path 212 allowing a discount to be set for each of several days “N” to be set through steps 204, 205, and
206. In this manner, each of the days prior to the expiration date can have an increasing discount to help assure products are sold before expiration. In this manner, each of the discount price options can be set.

In normal operation, the vending controller 12 will update the prices as described above to generate discount prices for products which are near their expiration. Referring again to FIG. 3, in the event a product has reached its expiration in step 102, the controller will not allow this product to be vended in step 116. The message displayed can then indicate the product life has expired or just direct the consumer to “select another [product]” in step 108.

The controller of the present invention can also advantageously apply a more “intelligent” discounting analysis in an effort to optimize profits. As an alternative to setting fixed discount rates based solely on time before product expiration, the time and amount of discount can be determined based on the prior sales history of the product. For example, by tracking the rate of sales of a given product, the controller can anticipate that a certain number of products should sell before the expiration of the product and determine if any discounting is required. If the rate of sales of that product is slower than required to insure all the available products will be sold, a small discount can be applied and the rate monitored to determine if sales now will result in the product being sold out before expiration. This process can be iterative and allow a progressive discount structure determined by the controller to help encourage product sales. Other more sophisticated sales data analyses can be employed and adapted as desired. The machine display can be used to help in the sales effort by “announcing” additional discounting to passing consumers. If the machine is equipped with a talking unit, this feature can also be used to announce the discounts available.

In many cases, vending machines are set up with specific products being put in specific vending positions, such as trays, spirals, columns, and the like. To the degree that an entire tray, spiral or column is filled with products of the same expiration date, no special detection is required to isolate specific products. It will be sufficient for the machine to have the information entered including the location and quantity of each product with an expiration date. In the case where the machine has products with mixed expiration dates intermixed, the specific locations of these products have to be identified and entered into the controller. This situation may require product presence sensors in the machine to determine if the product in question is still available for sale. These sensors can be simple optical sensors or one of a number of more complicated sensing or scanning systems. The uses of such sensors are well known in the art and will not be discussed further herein.

There are a number of systems on the market that allow the data relative to sales and cash to be transmitted to a host system periodically. In some wireless systems, this data can be transmitted in real time, especially for alarm conditions or machine entry, or as often as desired. These systems also generally allow the vending machines to be configured remotely and in some cases include the ability to set prices remotely. The current invention is applicable in conjunction with such host systems. The intelligence described above relative to the electronic controller in the vending machine equally will be supported by remote system software. That is, the tracking and determination of discounting can be done at the host system and the resulting product pricing can then be transmitted to the vending machine. This approach allows simpler electronics at the machine without sacrificing the benefits of the current invention. It will also be clear that with the additional power of a host computer system, the sophistication of the algorithms and logic used to determine the discount for maximum profit can be significantly greater.

While the present invention has been disclosed in the context of various aspects of presently preferred embodiments, it will be recognized that the invention may be suitably applied to other environments consistent with the claims which follow.

1. A vending machine controller comprising:
means for storing the expiration date of products loaded in a vending machine;
means for comparing the expiration date to the current date; and
means for applying a discount as the expiration date approaches the current date.

2. The vending machine controller of claim 1 further comprising:
means for controlling a vending machine display to display a discounted price.

3. The vending machine controller of claim 1 further comprising:
means for controlling a vending machine display to display a product expiration date for a selected product.

4. The vending machine controller of claim 1 further comprising:
means for computing the discount so that the discount is varied to increase sales and decrease product waste.

5. The vending machine controller of claim 1 further comprising:
means for preventing vending of a product whose expiration date has passed.

6. The vending machine controller of claim 1 further comprising:
means for setting progressive discounts for products as the expiration date nears.

7. The vending machine controller of claim 1 further comprising:
means for determining the discount based at least in part on a determination of remaining time to expiration.

8. The vending machine controller of claim 1 further comprising:
means for monitoring the rate of products being sold; and
means for calculating the discount based on the rate of product sales.

9. The vending machine controller of claim 1 further comprising:
a monitoring circuit to monitor the presence or absence of products; and
means for setting the discount based on the number of products available and the time remaining before the product expiration is reached.

10. A vending machine system comprising:
a vending machine controller;
a host computer system;
means for interconnecting the vending machine controller to the host system;
means for updating the host computer system with sales by product data;
the host system having means for tracking the time before each product in the machine expires; and
means for downloading new pricing to discount the price of products as they approach their expiration.

11. The vending machine system of claim 10 wherein the system further comprises means for calculating discount prices to optimize the price of a particular product near its expiration by monitoring and analyzing the sales trends for the particular product.

12. Software stored on a storage medium for controlling a vending machine controller to operate so as to reduce product waste by performing the following steps:
storing the expiration date of products loaded in a vending machine;
comparing the expiration date to the current date; and
applying a discount as the expiration date approaches the current date.

13. A method of vending machine control to reduce product waste comprising:
storing the expiration date of products loaded in a vending machine;
comparing the expiration date to the current date; and
applying a discount as the expiration date approaches the current date.

14. The method of claim 13 further comprising:
controlling a vending machine display to display a discounted price.

15. The method of claim 13 further comprising:
controlling a vending machine display to display a product expiration date for a selected product.

16. The method of claim 13 further comprising:
computing the discount so that the discount is varied to increase sales and decrease product waste.

17. The method of claim 13 further comprising:
preventing vending of a product whose expiration date has passed.

18. The method of claim 13 further comprising:
setting progressive discounts for products as the expiration date nears.

19. The method of claim 13 further comprising:
determining the discount based at least in part on a determination of remaining time to expiration.

20. The method of claim 13 further comprising:
monitoring the rate of products being sold; and
calculating the discount based on the rate of product sales.
